(19) United States
(12) Patent Application Publication
(10) Pub. No.: US 2008/0189994 A1
(43) Pub. Date: Aug. 14, 2008

(54) Display Device

(76) Inventor: Faul Bosman Swanepoel, Faerie Glen (ZA)

Correspondence Address: DARBY & DARBY P.C., P.O. BOX 770, Church Street Station, New York, NY, 10008-0770, US

(21) Appl. No.: 11/911,331

(22) PCT Filed: Apr. 11, 2006
(86) PCT No.: PCT/IB2006/051111

§ 371 Date: Apr. 4, 2008

(30) Foreign Application Priority Data
Apr. 13, 2005 (ZA) 2005/02977
Aug. 4, 2005 (ZA) 2005/06251
Dec. 20, 2005 (ZA) 2005/10334
Feb. 28, 2006 (ZA) 2006/01779

(51) Int. Cl. G09F 23/06

(52) U.S. Cl. 40/308

(57) ABSTRACT

The invention provides an advertising display device (10) which includes a display body (14) which is shaped and dimensioned to be secured to any one of the sides and the bottom of a hand basket (12) of the type used by shoppers in supermarkets. The body defines a display zone and is provided with securing means (26) for removably securing the body to any one of the sides (20) and the bottom (24) of the hand basket (12). The securing means preferably secures only one side edge portion of the body.

THIS INVENTION relates to relates to marketing. In particular, the invention relates to a method of advertising or marketing, to an advertising display device and to a display arrangement.

According to a first aspect of the invention, there is provided a method of advertising, the method including the step of removably securing a display device displaying advertising information about any one of goods and services to a hand basket.

The hand basket will typically be of the type used by shoppers in supermarkets.

The method may include removably securing a display device in the form of an advertising placard to the shopping basket. The display device may be removably secured to a side or to the bottom on an inside of the basket.

According to another aspect of the invention, there is provided an advertising display device which includes
a display body which is shaped and dimensioned to be secured to any one of the sides and the bottom of a hand basket of the type used by shoppers in supermarkets, the body defining a display zone; and
securing means on the body, for removably securing the body to any one of the sides and the bottom of the hand basket.

The body of the display device may be planar in shape.

In a simple embodiment of the invention, the planar body may be in the form of a placard or sticker which can simply be adhesively secured to the basket. In this embodiment the securing means will then be an adhesive.

The securing means may be operable to secure only one side edge portion of the display device to the said side or bottom

The display body may be hinged at, or adjacent, the said side edge portion so that the body can be raised and lowered lid-fashion.

The or each hinge may be provided by at least one of a score mark or a line of reduced thickness.

The securing means may be selected from fasteners, clips, clasps or the like which are attached to the display body and which are operable to releasably secure the display body to the basket. Preferably, the securing means will be integral with the planar body and will be in the form of at least one protrusion or engagement formation which is shaped to be engageable with at least one complementary formation on the said side or bottom of the basket. The at least one complementary formation may be shaped to be engageable with at least one opening in the said side or bottom. The or each opening may be formed for example by gaps between ribs of the shopping basket.

In one embodiment, the body of the display device will be of a planar, flexible, synthetic polymeric material, the display zone will be defined by at least one major surface of the body and the securing means will be in the form of flexible finger-like protrusions extending from two opposed sides of the planar body.

The securing means may thus be in the form of at least one flexible finger like protrusion extending from at least one side edge of the planer body. The spacing and dimensions of the finger-like protrusions may then be matched to engage with complementary formations such as gaps or openings in, or edges of, the sides or bottom of the basket. The openings may, for example, be formed by ribs forming parts of the sides or bottom of the hand basket. Advantageously, the planar body and the protrusions will be flexible to allow the protrusions to be hooked into or engaged with the openings or edges. The protrusions may be arrow-head shaped.

In use, this embodiment of the invention will typically be attached to the bottom of a shopping basket so that the display member is directed upwardly so as to be visible to a shopper using the shopping basket.

Preferably, the display device will be of a lightweight construction so as to add minimal weight to the hand basket. The display device will also preferably be of a water impervious material, such as the synthetic polymeric material referred to above, to be resistant to fluids which may leak onto the display device, or to condensation from cooled products which may come into contact with the device.

In a preferred embodiment of the invention, the display device will be of a flexible synthetic polymeric material which is of a layered or laminar construction comprising at least two sheets, at least one of which is transparent, the display zone being formed by a display member sandwiched between the at least two sheets. The display member may then be a sheet of a material such as paper, another synthetic polymeric material or the like. Preferably, the display member will be a sheet of a paper such as gloss art 135 gram paper on which promotional material is displayed for advertising purposes, for example by being litho-printed onto the sheet.

In a variation of this embodiment of the invention, the display device may be provided with an opening so that the display member can be inserted into, and removed from, the display device, envelope fashion, to locate it between the two sheets or to remove it from between the sheets. The opening may extend along at least one side edge of the device. The device may then be provided with closing or sealing means so that the opening can be closed or sealed once the display member has been inserted into the opening. The device will thus be in the form of a pouch.

The closing or sealing means may be a resealable tongue and groove type closure of the type known as Ziploc™ which is commonly used for resealable plastic bags such as sandwich bags and the like.

As mentioned before, in preferred embodiments of the invention, the body of the display device will have fastening means operable to secure only one edge portion of the display device to the sides or bottom of a shopping basket and the display body may then be hinged at, or adjacent, the said edge portion so that the body can be raised and lowered lid-fashion.

For example, the fastening means may be in the form of laterally protruding engagement formations, such as the fingerplike protrusions referred to above, and hinges may be provided by scoring the display body or by providing the display body with lines of reduced thickness so that the body can be hingedly folded about the score line or line of reduced thickness. Instead, the hinges may be provided simply by the flexibility of the material from which the device is made, without any score lines or lines of reduced thickness.

The advantage associated with these embodiments of the invention is that they are very easy to clean. Because the body of the device can be hingedly raised (whether or not a score mark or line of reduced thickness is provided) any undesired material such as food particles, dirt, dust or the like which may otherwise become lodged behind the body and which would otherwise be difficult to dislodge can easily be removed by raising the body of the device and washing or rinsing the rear of the body and the part of the basket which becomes uncovered by raising the body of the device.

In a sophisticated embodiment of the invention, the display device may include an electronic display screen, such as a liquid crystal display (LCD), or the like.

The invention extends further to a display arrangement, which includes a hand basket and a display device as hereinbefore described.

In a different embodiment of the invention, the securing means may be in the form of a mounting frame, secured to a side or bottom of the basket in which an advertising placard or poster may be mounted. The mounting frame may include guides within which a placard may slidingly be received.

The invention extends to an advertising device which includes a display body which is shaped and dimensioned to be secured to any one of the sides and bottom of a hand basket of the type used by shoppers in supermarkets, the body being of a layered construction comprising at least two sheets, at least one of which is transparent, the body having at least one opening so that a display member can be removably located between the sheets, and securing means on the body, for removably securing the body to any one of the sides and bottom of the hand basket.

The invention will now be described, by way of example only, with reference to the following drawings in which

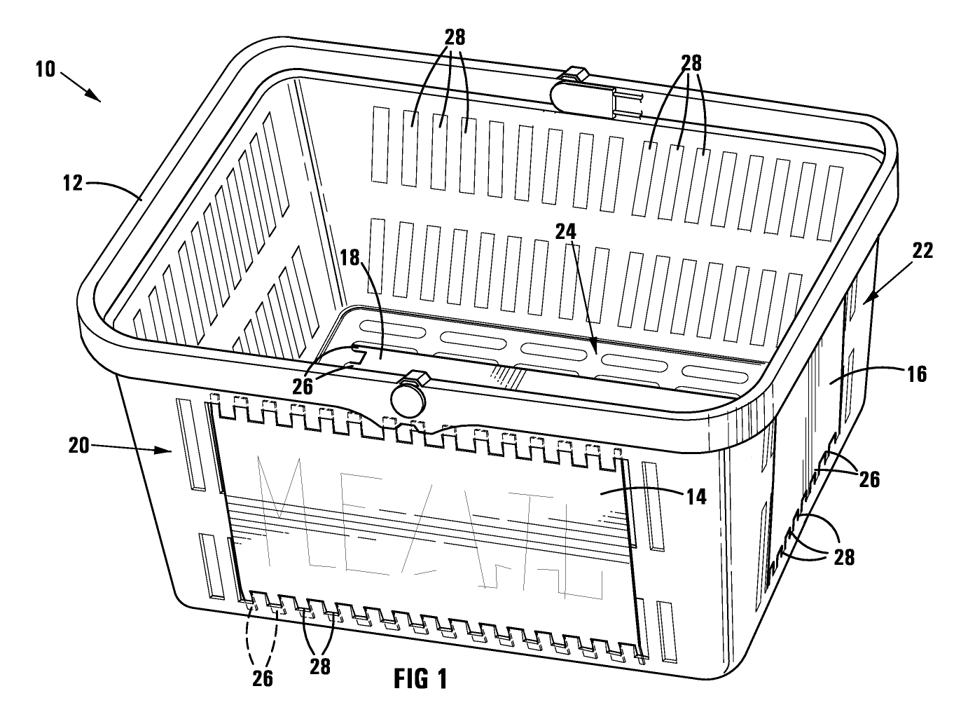

FIG. 1 shows display devices and a display arrangement in accordance with the invention;

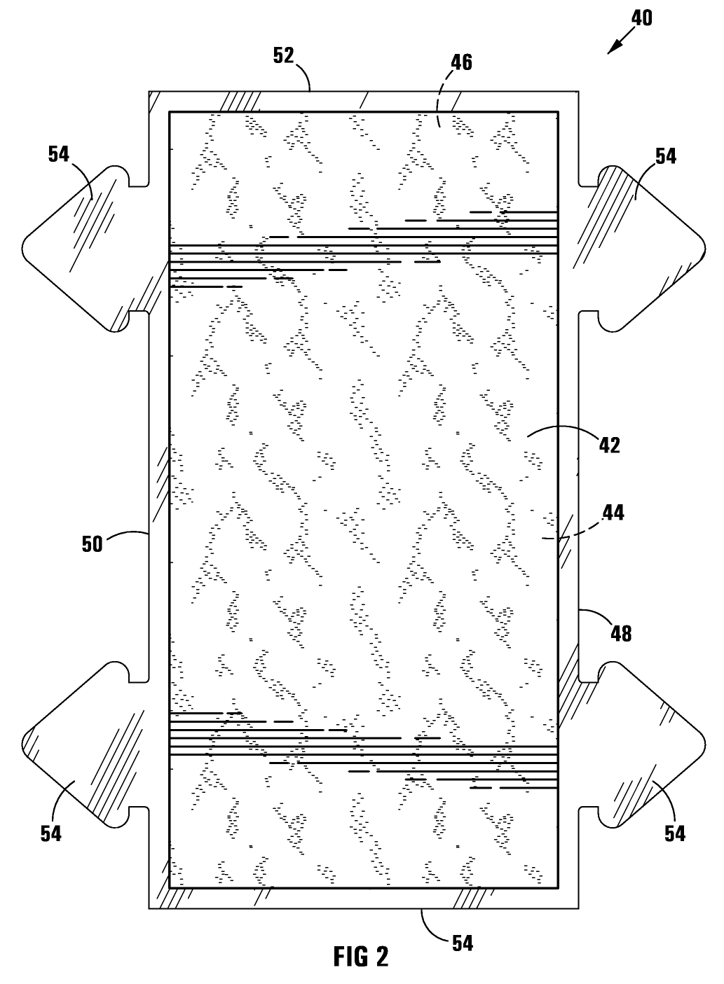

FIG. 2 shows a plan view of another embodiment of a display device;

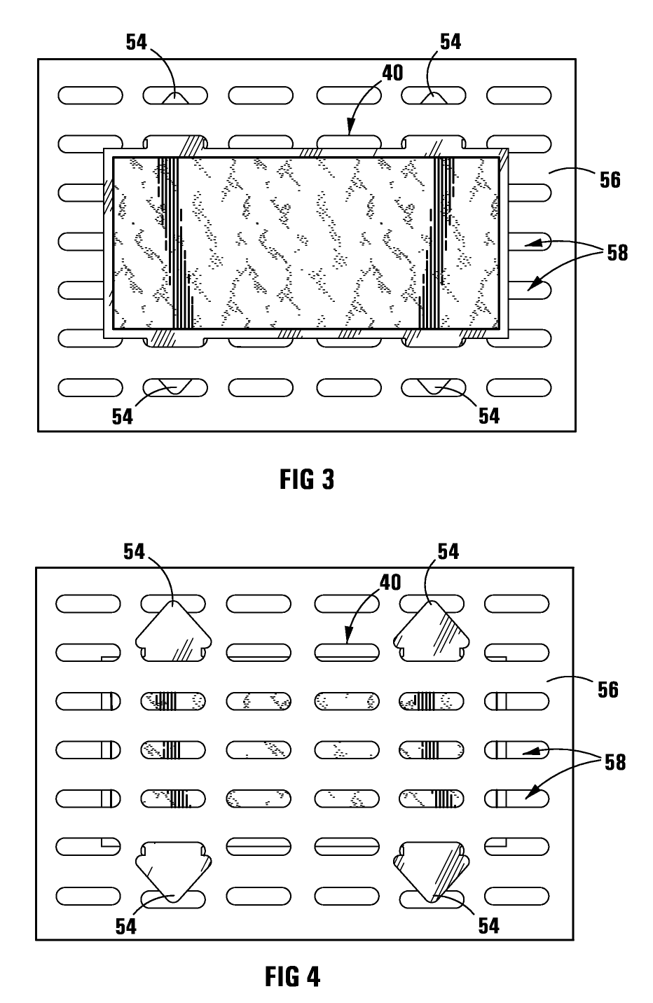

FIG. 3 shows a top view of part of another embodiment of a display arrangement incorporating the display device of FIG. 2;

FIG. 4 shows a bottom view of the display arrangement of FIG. 3;

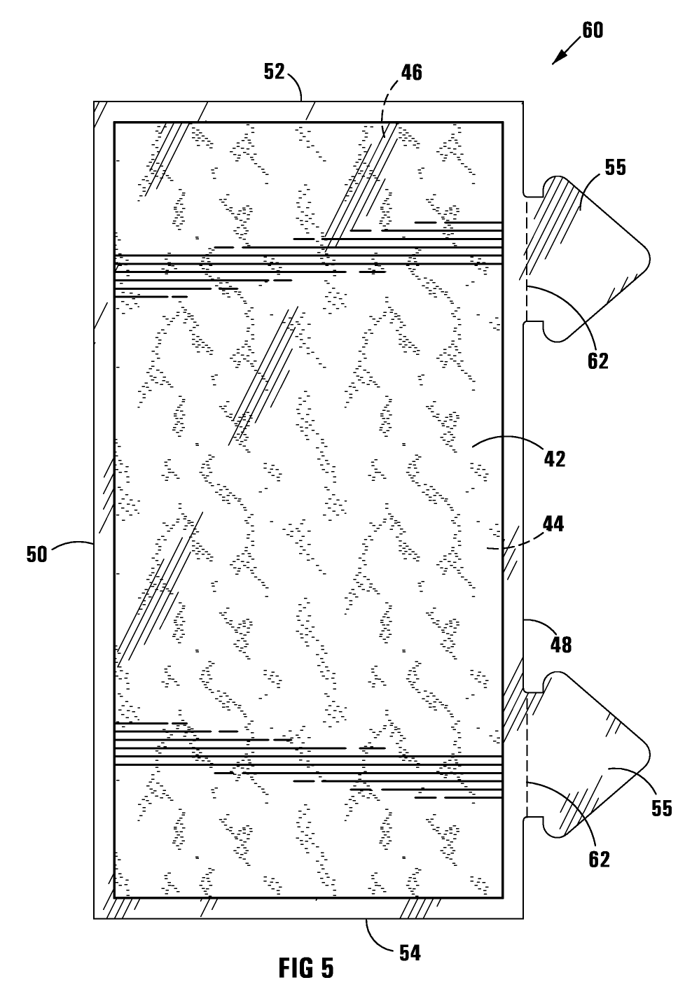

FIG. 5 shows another embodiment of a display device in accordance with the invention;

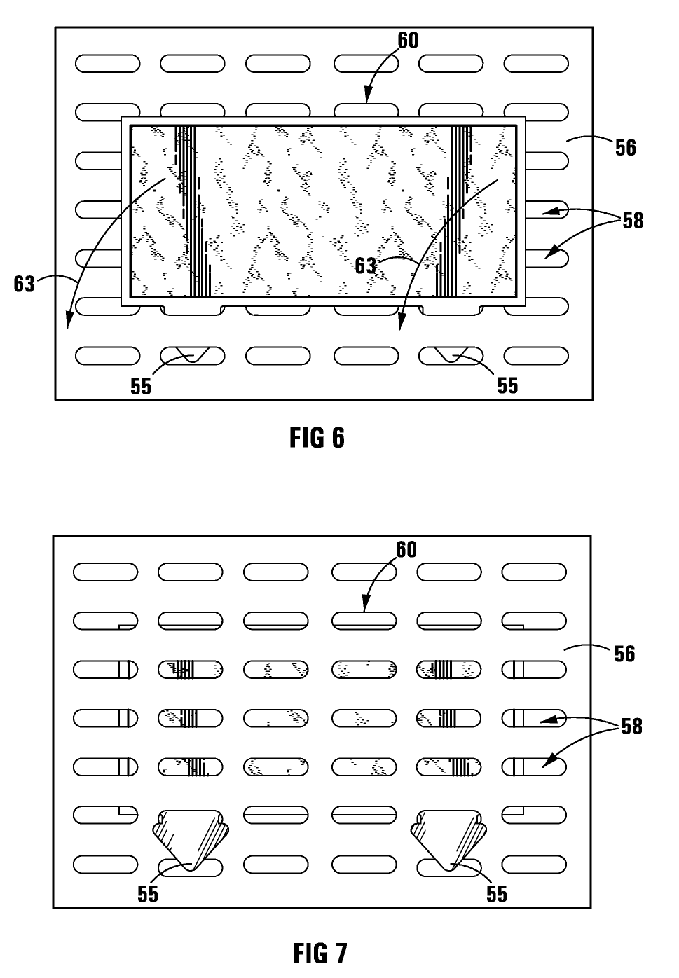

FIG. 6 shows a top view of the display device of FIG. 5 attached to the bottom of a hand basket;

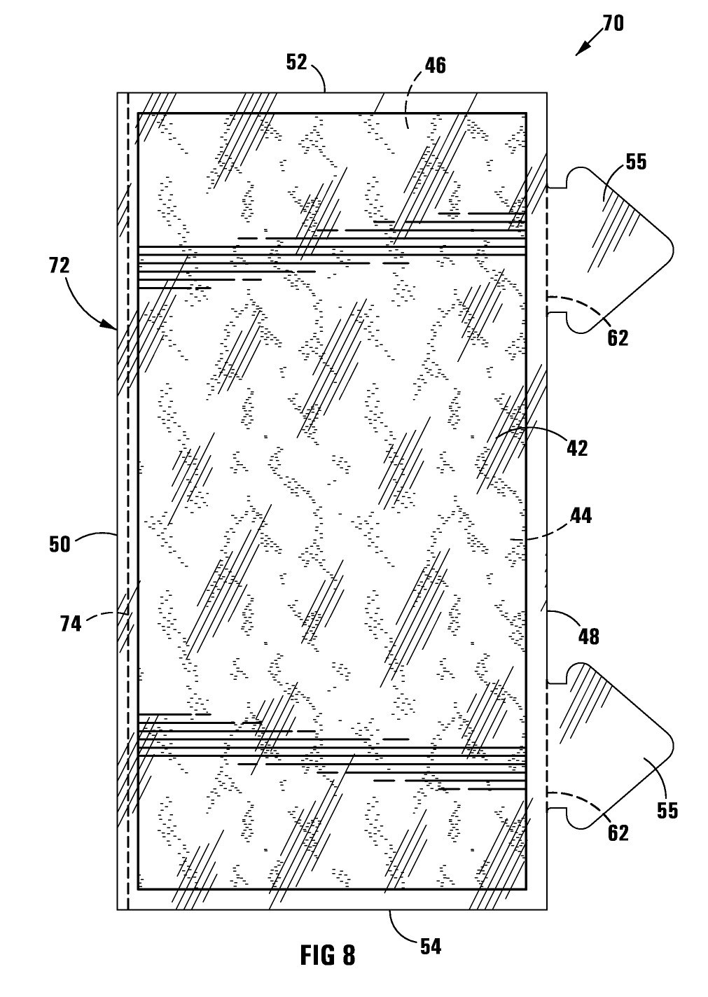

FIG. 7 shows a bottom view of the device and hand basket of FIG. 6; and

FIG. 8 shows another embodiment of a display device in accordance with the invention.

Referring to FIG. 1, reference numeral 10 generally indicates a display arrangement which includes a hand shopping basket 12 and three display devices 14, 16 and 18. In different embodiments of the invention, the display devices 14, 16, 18 are in the form of placards of a flexible synthetic material or are of a laminated construction comprising two sheets of a synthetic polymeric material with a sheet of paper or the like laminated between the two sheets.

The placard 14, is removably attached on one side 20 of the hand shopping basket 12, the placard 16 is removably attached on another side 22 of the basket 12 and the placard 18 is removably attached to an inside floor 24 of the basket 12. The three placards 14, 16, 18 define display zones on at least one of their outer surfaces on which advertisements are displayed.

The placards 14, 16, 18 are planar and generally rectangular in shape and each has fastening means in the form of finger-like protrusions 26 extending from opposing upper and lower edge portions. The hand basket 12 is provided with parallel rows of vertically extending rectangular slots 28, in conventional fashion, in its sides 20, 22 and in its base 24 and the protrusions 26 are dimensioned and spaced to clip into the slots 28.

In different embodiments of the invention the information displayed on the placards 14, 16, 18 is marketing material displaying goods or services of suppliers.

Advantageously, the placards 14, 16, 18 are of a water impervious synthetic material, so as to be resistant to liquid spillage or condensation from cooled products.

Because the material from which the placards 14, 16, 18 is made is flexible, the placards 14, 16, 18 can be replaced, or exchanged with ease, allowing the placards to be readily replaced with the placards of other advertisers.

The combination of the basket 12 and the placards 14, 16, 18 defines the display arrangement 10.

Referring now to FIG. 2, reference numeral 40 generally indicates another embodiment of a display device in accordance with the invention. The display device 40 is of laminar construction and is manufactured from two sheets 42, 44 of 250 micron laminating film. A display member 46 is laminated between the sheets 42, 44 and the resulting laminated structure is die-cut to shape. The display member 46 is in the form of a sheet of gloss art 135 gram paper on which promotional material (not shown) is displayed for advertising purposes. The display device 40 is generally rectangular in shape having longer side edges 48, 50 and shorter side edges 52, 54. Arrow-head shaped engagement formations 55 protrude from the longer side edges 48, 50 for engagement with a shopping basket.

FIGS. 3 and 4 show the display device 40 of FIG. 2 engaged with the base 56 of a shopping basket (not shown). The base 56 of the shopping basket is provided was parallel rows of elongate slots 58 in conventional fashion and the engagement formations 55 are inserted into four of the slots 58 thereby securing the display device 40 to the base 56 of the shopping basket. In FIG. 3 the base 56 of the shopping basket is shown from above and in FIG. 4 the base 56 is shown from below. The shape of the engagement formations 54 ensures that the device 40 is firmly attached to the base 56 of the shopping basket so that accidental dislodgement is unlikely. Because the device 40 is flat against the base 56 of the shopping basket, it is also unlikely that it will interfere with any goods packed into the shopping basket.

Referring now to FIGS. 5, 6 and 7, reference numeral 60 generally indicates another embodiment of a display device in accordance with the invention. The display device 60 resembles the display device 40 of FIG. 2 and the same reference numerals have been used to indicate the same or similar features of the devices 60 and 40. In FIGS. 6 and 7, the device 60 is shown engaged with the base 56 of a shopping basket (not shown) in the same way as the display device 40 of FIGS. 3 and 4. The device 60 is also of laminar construction and is manufactured in the same way as the device 40 with a display member 46 laminated between sheets 42, 44 and with the resulting laminated structure die-cut to shape. The display member 46 is also in the form of a sheet of gloss art 135 gram paper on which promotional material (not shown) is displayed for advertising purposes. The display device 60 is also generally rectangular in shape having longer side edges 48, 50 and shorter side edges 52, 54. However, the display device 60 differs from the device 40 in that the arrow-head shaped engagement formations 55 protrude from only the side edge 48 for engagement with the shopping basket. The device 60 further differs from the device 40 in that score lines or lines of reduced thickness 62 are provided adjacent the engagement formations 55 so that the body of the device 60 can be hingedly displaced or folded upwardly in the direction of the arrows 63 as shown in FIG. 6 while remaining attached to the basket. In this way the display arrangement formed by the device 60 and the basket can easily be cleaned or washed and unwanted material will not become lodged behind the display device 60.

In a variation of this embodiment of the invention (not shown) second score lines are provided adjacent the score lines 62 and spaced slightly into the engagement formations 55. In this embodiment a double folding takes place when the body of the device 60 is folded upwardly and provides a resilient springlike return action to the body 60.

In another variation of this embodiment of the invention the thickness of the material used in the construction of the display device 60 is sufficient to allow hinge-like folding without the need for the score lines 62.

Referring now to FIG. 8, reference numeral 70 generally indicates another embodiment of a display device in accordance with the invention. The display device 70 resembles the display device 60 of FIG. 5 and the same reference numerals have again been used to indicate the same or similar features of the devices 70 and 60. The display device 70 differs from the device 60 in that an opening 72 extends along the length of the side edge 50 and provides access to the space between the sheets 42, 44. In addition, the display device 70 includes a tongue and groove resealable closure mechanism of the type known as a Ziploc™ (shown schematically by the dotted line 74). This type of closure is commonly used for sandwich bags or plastic coin bags of the type issued by banks and consists of a plastic strip which is received as a friction fit in a corresponding groove.

In use, the Ziploc™ closure 74 is opened and the display member 46 is inserted through the opening so that it is located between the sheets 42, 44 as shown in the drawings. In this embodiment of the invention, the display member 46 can readily be removed from the display device 70 and replaced with a new display member 46. In this way the information displayed by the display device 70 can easily be changed when required by an advertiser. The Ziploc™ closure 74 also serves to prevent ingress of moisture or dirt between the sheets 42, 44. Naturally, the opening 72 may be provided along one of the shorter side edges 52, 54.

It is an advantage of the invention that the display devices 40, 60, 70 are placed inside a shopping basket. This will result in a shopper seeing the advertisement displayed on the devices 40, 60, 70 at least three times. The first time will be when the shoppers selects the particular basket, the second time will be (at least) when the first product is placed into the basket and the third time will be at the point of purchase when products are taken out of the basket. It is a further advantage of this embodiment of the invention that the display devices 40, 60, 70 provide a low cost in-store advertising medium which is quick to install, visually complements the shopping basket and will not easily be dislodged. It is a further advantage that the devices can be manufactured to fit all standard baskets.

The Applicant has found that, in the UK alone, about £1,15 billion is spent annually on promoting products at point of purchase. Research has shown that in-store fixtures provide the best marketing tools for guaranteeing a good return-on-investment (ROI). For short-term sales increases, according to a survey of 300 campaigns which considered sales increase in terms of revenue against the cost of activity, it has been found that in-store fixtures give an average of 160% ROI. By comparison there was a 20% return for sampling, a 46% return for television advertisements and a 20% return for direct mail. It is currently claimed that many companies believe that up to 80% of brand decisions are now made in-store.

The promotional basket insert of the invention transforms baskets from an historic overhead to an income-generating product. The invention provides a new and creative way for in-store advertising. By placing the advertisement on the inside of a basket, the advertisement directly promotes an in-store product but does not change the retail image of the relevant store.

The inventor believes that the invention as illustrated provides a new display device and a new display arrangement, for use in a new method of marketing. The inventor also believes that the invention as illustrated has the advantage that marketing material can be displayed to a large number of people, by using hand baskets to display the information. Also, when needed, the marketing material can readily be changed without damage to the hand basket.

1. A method of advertising, the method including the step of removably securing a display device displaying advertising information about any one of goods and services to a hand basket of the type used by shoppers in supermarkets.

2. A method as claimed in claim 1, in which the display device is in the form of an advertising placard.

3. A method as claimed in claim 1 or claim 2, in which the display device is removably secured to a side or to a bottom on an inside of the basket.

4. An advertising display device which includes
a display body which is shaped and dimensioned to be secured to any one of the sides and the bottom of a hand basket of the type used by shoppers in supermarkets, the body defining a display zone; and
securing means on the body, for removably securing the body to any one of the sides and the bottom of the hand basket.

5. An advertising display device as claimed in claim 4, in which the body of the display device is planar in shape.

6. An advertising device as claimed in claim 4 or claim 5, in which the securing means is operable to secure only one side edge portion of the display device to the said side or bottom.

7. An advertising device as claimed in claim 6, in which the display body is hinged at, or adjacent, the said side edge portion so that the body can be raised and lowered lid-fashion.

8. An advertising display device as claimed in any one of claims 4 to 7, in which the securing means is selected from fasteners, clips and clasps which are attached to the display body and which are operable to releasably secure the display body to the basket.

9. An advertising display device as claimed in any one of claims 4 to 7, in which the securing means is integral with the planar body and is in the form of at least one engagement formation which is shaped to be engageable with at least one complementary formation on the said side or bottom.

10. An advertising display device as claimed in claim 9, in which the at least one complementary engagement formation is shaped to be engageable with at least one opening in the said side or bottom.

11. An advertising display device as claimed in claim 9 or claim 10, in which the securing means is in the form of at least one flexible finger-like protrusion extending from at least one side edge of the planar body.

12. An advertising display device as claimed in claim 11, in which the body is of a flexible, synthetic polymeric material which is of layered construction comprising at least two sheets, at least one of which is transparent, the display zone being formed by a display member sandwiched between the at least two sheets.

13. An advertising display device as claimed in claim 12, in which the display member is a sheet of a material selected from paper and synthetic polymeric materials

14. An advertising display device as claimed in claim 13, in which the body of the display device is provided with an opening so that the display member can be removed and replaced.

15. An advertising display device as claimed in claim 14, which is provided with closing or sealing means so that the opening can be closed or sealed once the display member has been inserted into the opening.

16. An advertising device as claimed in claim 15, in which the closing or sealing means is a resealable tongue and groove type closure.

17. An advertising display body as claimed in claim 7, in which the or each hinge is provided by at least one of a score mark or a line of reduced thickness.

18. A display arrangement, which includes a hand basket and a display device as claimed in any one of claims 1 to 17, inclusive.

19. An advertising device which includes a display body which is shaped and dimensioned to be secured to any one of the sides and bottom of a hand basket of the type used by shoppers in supermarkets, the body being of a layered construction comprising at least two sheets, at least one of which is transparent, the body having at least one opening so that a display member can be removably located between the sheets, and securing means on the body, for removably securing the body to any one of the sides and bottom of the hand basket.
